(19) United States
(12) Patent Application Publication
(10) Pub. No.: US 2012/0103132 A1
(43) Pub. Date: May 3, 2012

(54) TRANSMISSION CASE FOR HYBRID VEHICLES

(75) Inventors: MERRITT J. MORRIS, LONG BEACH, CA (US); WILLIAM S. REED, GREENFIELD, IN (US)

(73) Assignee: GM GLOBAL TECHNOLOGY OPERATIONS LLC, DETROIT, MI (US)

(21) Appl. No.: 13/277,998

(22) Filed: Oct. 20, 2011

Related U.S. Application Data
(60) Provisional application No. 61/409,025, filed on Nov. 1, 2010.

(51) Int. Cl. F16H 57/02; H01R 13/60

(52) U.S. Cl. 74/606 R; 439/575

(57) ABSTRACT

A transmission assembly is provided. The transmission assembly includes a transmission case with at least one wall having an interior side and an exterior side; a transmission component arranged within the transmission case; an interface formed in the wall of the transmission case; and a connector secured to the wall at the interface with a snap-in connection that substantially prevents axial, radial, and rotational movement between the connector and interface.

### PRIORITY CLAIMS

This application claims the benefit of U.S. Provisional Application No. 61/409,025, filed Nov. 1, 2010, incorporated herein by reference.

### TECHNICAL FIELD

The present invention generally relates to hybrid vehicles, and more particularly relates to transmission cases of engine systems in hybrid vehicles.

### BACKGROUND

A vehicle transmission typically delivers mechanical power from an engine to the remainder of a drive system, such as fixed final drive gearing, axles, and wheels. In some vehicles, particularly hybrid vehicles, the transmission is incorporated into a transmission assembly with one or more motors, pumps, and other components sealed within a case or module. Such transmission components may require power or control signals from components or systems outside of the transmission assembly. Providing reliable connections between components within the transmission assembly and components outside of the transmission assembly may be difficult, particularly during the various manufacturing, assembly, and testing phases of the vehicle. This is particularly true with respect to automated assembly and testing in which connections are automatically located, positioned, and secured to provide reliable connections.

Accordingly, it is desirable to provide transmission cases with improved interfaces for receiving pass through connectors that enable electrical coupling between transmission components and external components in a simple and reliable manner. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, a transmission assembly is provided. The transmission assembly includes a transmission case with at least one wall having an interior side and an exterior side; a transmission component arranged within the transmission case; an interface formed in the wall of the transmission case; and a connector secured to the wall at the interface with a snap-in connection that substantially prevents axial, radial, and rotational movement between the connector and interface.

In accordance with another exemplary embodiment, a connection assembly includes an interface and a connector. The interface is formed in a wall of a case and includes a main cylinder extending through the wall, a chamfer on a first side of the main cylinder, a counterbore on the first side of the main cylinder, ribs on the first side of the main cylinder, and a vertical face on a second side of the main cylinder. The connector is secured to the wall at the interface with a snap-in connection that substantially prevents axial, radial, and rotational movement between the connector and interface by engaging the main cylinder, the chamfer, the counterbore, the ribs, and the vertical face of the interface.

### BRIEF DESCRIPTION OF THE DRAWINGS

The present invention will hereinafter be described in conjunction with the following drawing figures, wherein like numerals denote like elements, and

FIG. 1 is a functional block diagram of an exemplary engine system in accordance with an exemplary embodiment;

FIG. 2 is a schematic representation of a transmission case of the engine system of FIG. 1 in accordance with an exemplary embodiment;

FIG. 3 is an isometric interior view of an interface of the transmission case of FIG. 1 in accordance with an exemplary embodiment;

FIG. 4 is an isometric exterior view of the interface of FIG. 3 in accordance with an exemplary embodiment;

FIG. 5 is a cross-sectional view of the interface of FIG. 4 in accordance with an exemplary embodiment;

FIG. 6 is a first isometric interior view of the interface of FIG. 4 partially engaged with a connector in accordance with an exemplary embodiment;

FIG. 7 is a second isometric interior view of the interface of FIG. 4 partially engaged with a connector in accordance with an exemplary embodiment;

FIG. 8 is an isometric interior view of the interface of FIG. 4 engaged with a connector in accordance with an exemplary embodiment;

FIG. 9 is an isometric exterior view of the interface of FIG. 4 engaged with a connector in accordance with an exemplary embodiment; and

FIG. 10 is a cross-sectional view of the interface of FIG. 4 engaged with a connector in accordance with an exemplary embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Broadly, exemplary embodiments discussed herein are directed to transmission cases with interfaces for mating with and securing pass through connectors to be coupled with components external to the transmission case. Each interface includes features for securing the connectors in radial, axial, and rotational dimensions such that electrical signals may be reliably passed through the transmission case from exterior components or systems to components or systems within the transmission case as the transmission components are protected from the environment.

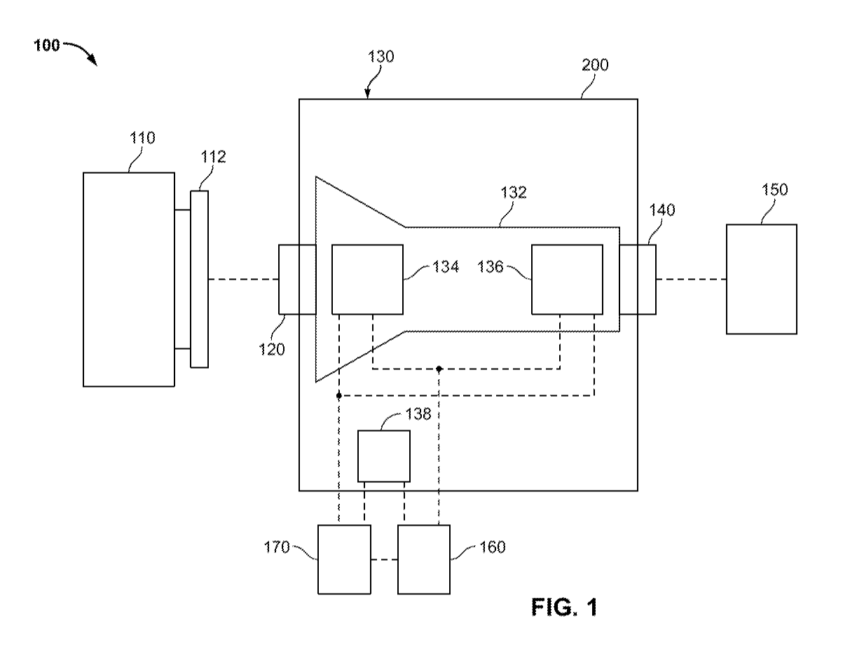

FIG. 1 is a schematic diagram of an engine system 100, such as that incorporated into a hybrid vehicle, according to an exemplary embodiment. The engine system 100 includes an engine 110, which may be any type of internal combustion engine, turning an engine output 112 that transmits the driving power produced by the engine 110. Driving power is then transferred through a transmission input shaft 120 into a transmission assembly 130.

The transmission assembly 130 includes a transmission 132 with planetary gear members (not shown) or other torque transfer devices (not shown). As examples, the transmission 132 may be an electrically variable transmission, a one or two-mode input split transmission, a two-mode transmission with input-split and compound-split, or other type of transmission. The transmission 132 utilizes the input shaft 120 to receive power from the engine 110 and a transmission output 140 to deliver power to drive the vehicle through one or more drive wheels 150. The fluid in transmission assembly 130 is pressurized by a pump 138. The pressurized fluid may be used for functions such as cooling, lubrication, and, in some cases, operation of the torque transfer devices. In one exemplary embodiment, the pump 138 has an internal high voltage alternating current (AC) electric pump motor.

The transmission assembly 130 may include one or more motors (or motor/generators) 134 and 136 capable of both converting electric power into mechanical power and converting mechanical power into electric power. The motors 134 and 136 are operatively connected to a battery 160 or any other type of energy storage device such that the battery 160 may accept power from, and supply power to, the motors 134 and 136. In general, the battery 160 may be a single chemical battery or battery pack, multiple chemical batteries, or other energy storage device suitable for hybrid vehicles. Other electric power sources, such as fuel cells, that have the ability to provide, or store and dispense, electric power may be used in place of battery 160.

A control system 170 regulates power flow among the battery 160 and the motors 134 and 136, as well as between the motors 134 and 136. As particularly shown, the control system 170 and battery 160 are also coupled to the pump 138 for respectively providing control signals and power to the pump 138. The control system 170 may further control the engine 110 and operation of the transmission 132 to select the output characteristics transferred to the drive wheels 150.

The transmission assembly 130 is substantially enclosed by a main transmission case 200, as will be discussed in greater detail below. The transmission assembly 130 may be fully assembled within transmission case 200 for testing and subsequent incorporation into the hybrid engine system 100. As described below, the transmission case 200 may have one or more interfaces that enable power or control signals to pass between the transmission assembly 130 and external components or systems.

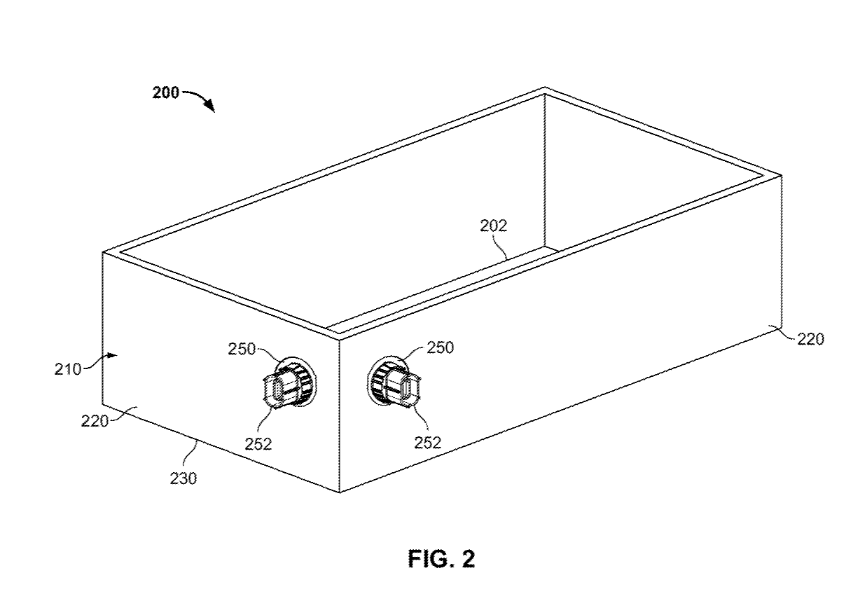

FIG. 2 is a schematic representation of the transmission case 200 of the engine system 100 of FIG. 1 in accordance with an exemplary embodiment. The components of the transmission assembly 130 have been removed from the transmission case 200 for clarity in the description below, except for an exemplary transmission component 202. The transmission component 202 may be any component of the transmission assembly 130, such as, for example, the motors 134 and 136 and the pump 138 discussed with reference to FIG. 1. Although the term “case” is used, exemplary embodiments discussed herein are applicable to any housing, case, module, or body forming an enclosure requiring the adaption of another component installed in a precise position that must pass from the interior to exterior while maintaining a seal to the environment. Other examples include an engine block that accommodates a pass through component.

As shown, the transmission case 200 may include a body 210 with side walls 220 and a base 230. The body 210 may be cast or molded and machined into any suitable shape, as necessary or desired to accommodate the transmission assembly 130 (FIG. 1) within a vehicle. The side walls 220 may include one or more interfaces 250 that receive connectors 252 from the transmission component 202 that pass through the body 210 of the transmission case 200. The connectors 252 are respectively fixed at the interfaces 250 for coupling to components or systems outside of the transmission case 200. In one exemplary embodiment, the connectors 252 may enable electrical signals, including control signals or power, to be sent or received by the transmission component 202. For example, the transmission component 202 may be the pump 138 (FIG. 1) and the connector 252 may be electrically coupled to the pump 138. In turn, the connector 252 may be additionally coupled to a corresponding connector of the battery 160 or control system 170 (FIG. 1) such that power or control signals may be provided to the pump 138. In another example, the connectors 252 may electrically couple the motors 134 and 136 (FIG. 1) or other transmission components to other systems or components.

As described below, the interfaces 250 of the transmission case 200 are designed to assist assembly and improve engagement with the connectors 252 without compromising the structural seals of the transmission case 200. In particular, the interfaces 250 guide proper assembly and secure engagement with the connectors 252 in each of the radial, axial, and rotational dimensions. As a result, the connectors 252 are appropriately positioned for later assembly into the engine system 100 and/or the vehicle. For example, the connectors 252 eliminate the need for pigtail cables hanging off the transmission during transport between a transmission assembly and vehicle assembly.

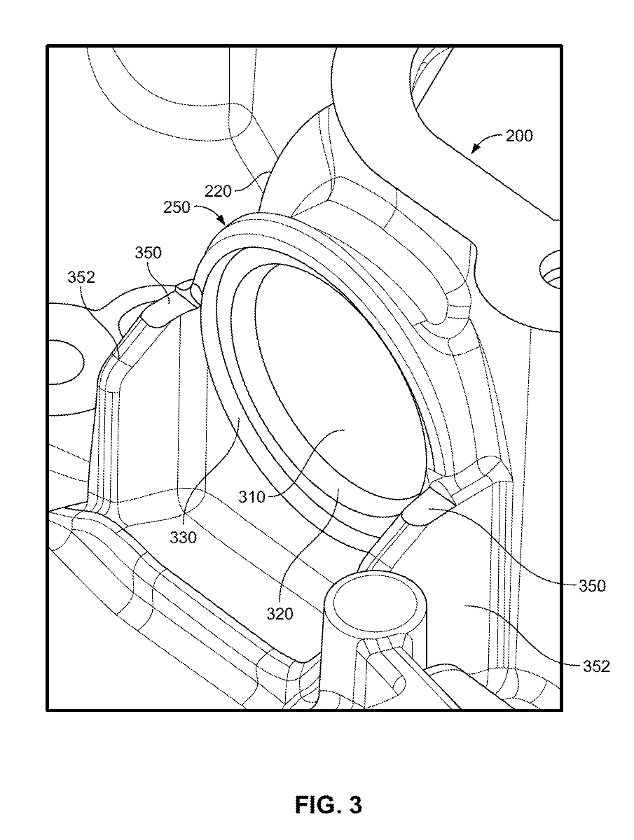

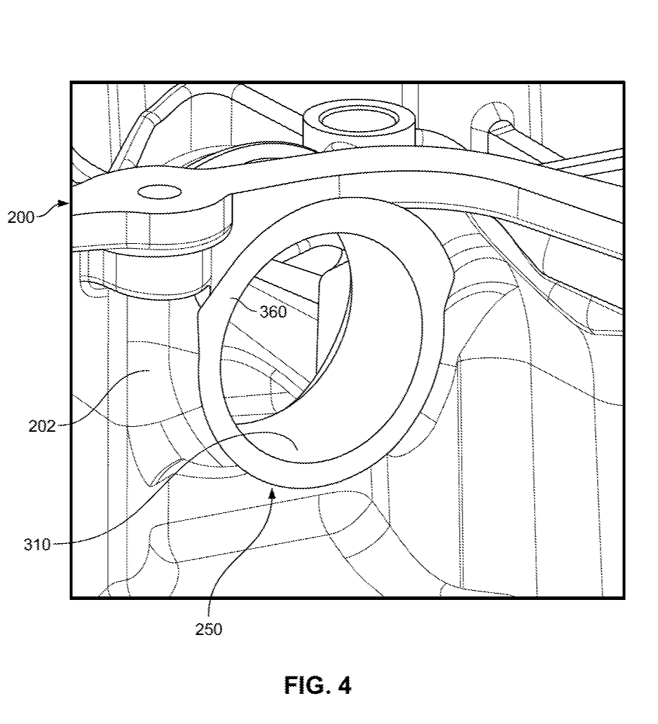

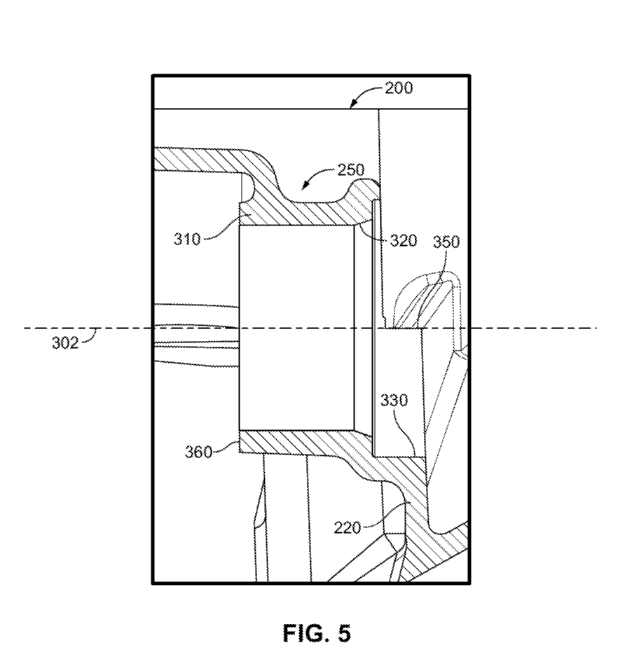

Additional details about the interfaces 250 are provided below with reference to FIGS. 3-5. FIG. 3 is an isometric interior view of an interface (e.g., interface 250 of FIG. 2) of the transmission case 200 of FIG. 1 in accordance with an exemplary embodiment. FIG. 4 is an isometric exterior view of the interface 250, and FIG. 5 is a cross-sectional view of the interface 250. In the views of FIGS. 3-5, the connector 252 has been removed for clarity.

Referring to FIGS. 3-5, the interface 250 is formed in the side wall 220 of the transmission case 200 which generally refers to any wall of the transmission case 200. In one exemplary embodiment, the interface 250 includes a main cylinder 310, a chamfer 320, a counterbore 330, and ribs 350.

The main cylinder 310 is a cylindrical structure that passes through the side wall 220. As such, the main cylinder 310 has walls that are generally parallel to a longitudinal axis 302 of the interface 250 and perpendicular to the side wall 220, although other arrangements are possible.

As best shown in FIGS. 3 and 5, the chamfer 320 is an annular structure, axially adjacent the main cylinder 310 on the interior side. The chamfer 320 is cylindrical with angled walls, e.g., with an axial angle relative to the main cylinder 310 and relative to the axis 302. The counterbore 330 is formed in the side wall 220 of the case 200, axially adjacent to the chamfer 320 on the interior side. As shown, the counterbore 330 may be a partial annular structure, e.g., the counterbore 330 is provided around only a portion of the chamfer 320. In one exemplary embodiment, the counterbore 330 is formed on the bottom half (e.g., bottom radial half) of the interface 250.

The ribs 350 are planar structures, typically horizontal, formed in support structures 352 positioned on opposing horizontal sides of the interface 250. In one exemplary embodiment, the ribs 350 are in the same horizontal plane on opposing radial sides of the main cylinder 310, chamfer 320, and counterbore 330, although other arrangements may be provided. In one exemplary embodiment, the ribs 350 are parallel to an oil pan sealing surface of the transmission case 200. Horizontal ribs 350, as shown, may limit the overall tolerance stack more than vertical ribs.

FIG. 4 is a view of the interface 250 from the exterior side of the side wall 220. As shown, the interface 250 additionally has a vertical face 360 on the exterior side, as is discussed in greater detail below.

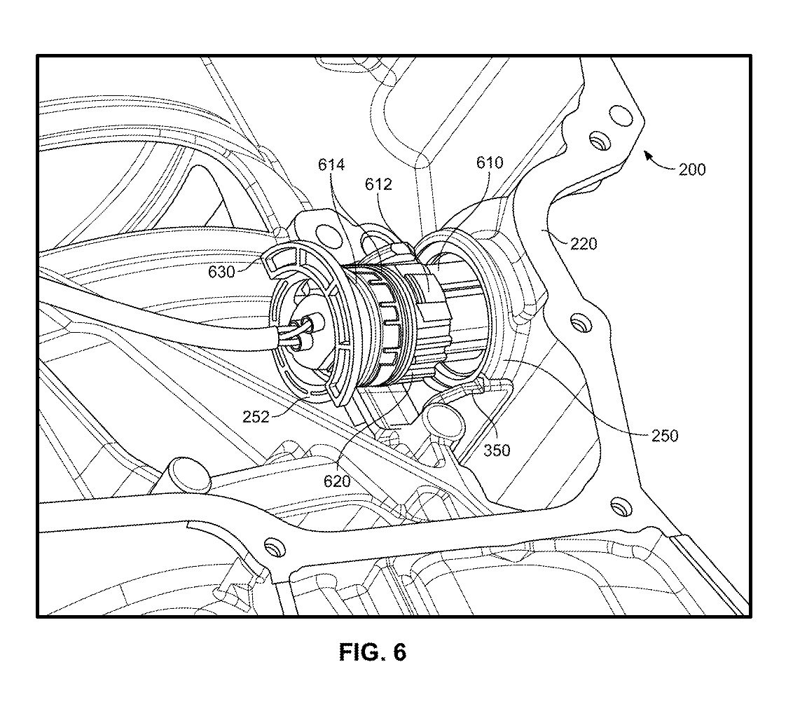

As noted above, the interface 250 is configured to receive a pass through connector (e.g., connector 252) that enables an electrical coupling between a component inside the transmission case 200 (e.g., component 202 in FIG. 2 or the pump 138 and/or motors 136 and 136 in FIG. 1) to a component or system outside of the transmission case 200. Additional details about the interaction of the connector 252 with the main cylinder 310, chamfer 320, counterbore 330, and ribs 350 are described below with reference to FIGS. 6-10.

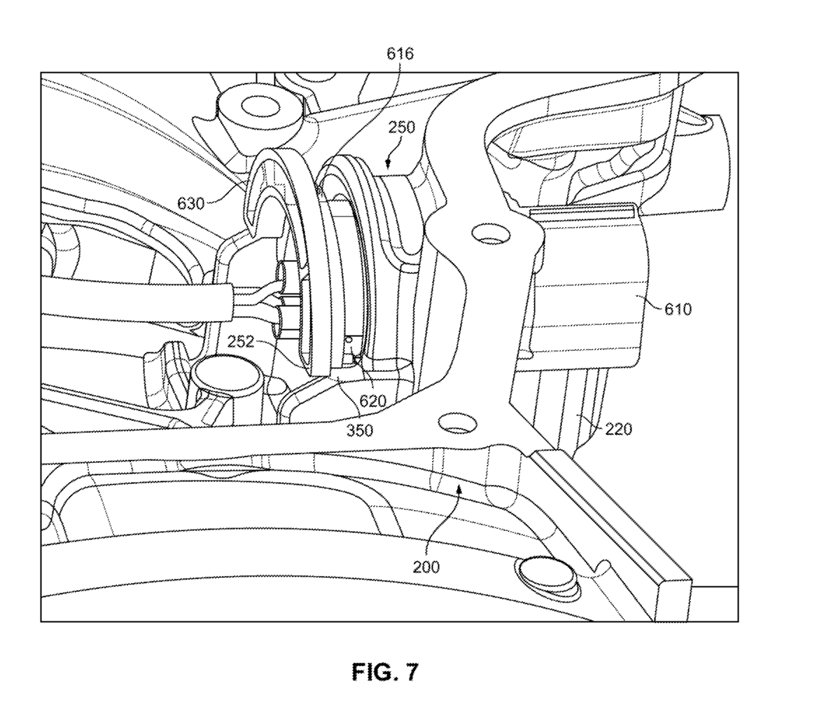

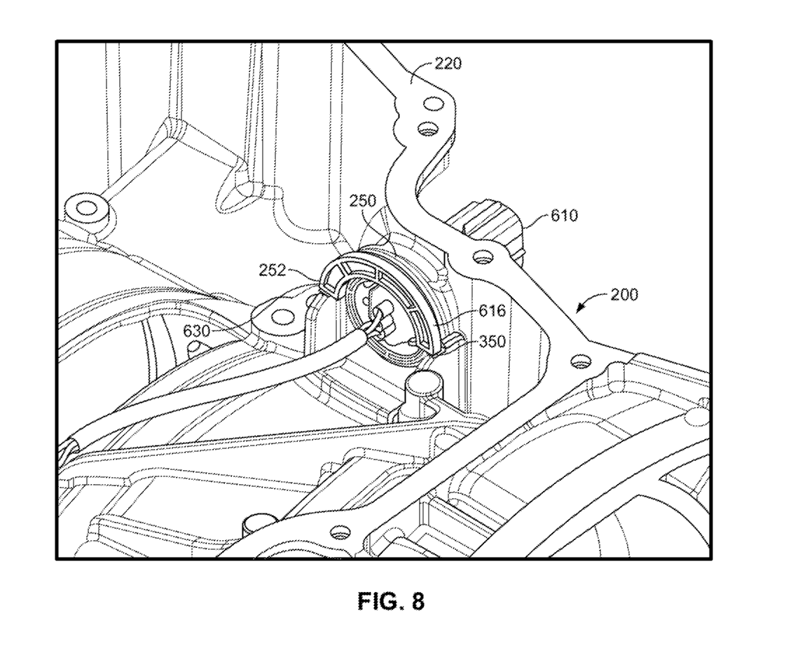

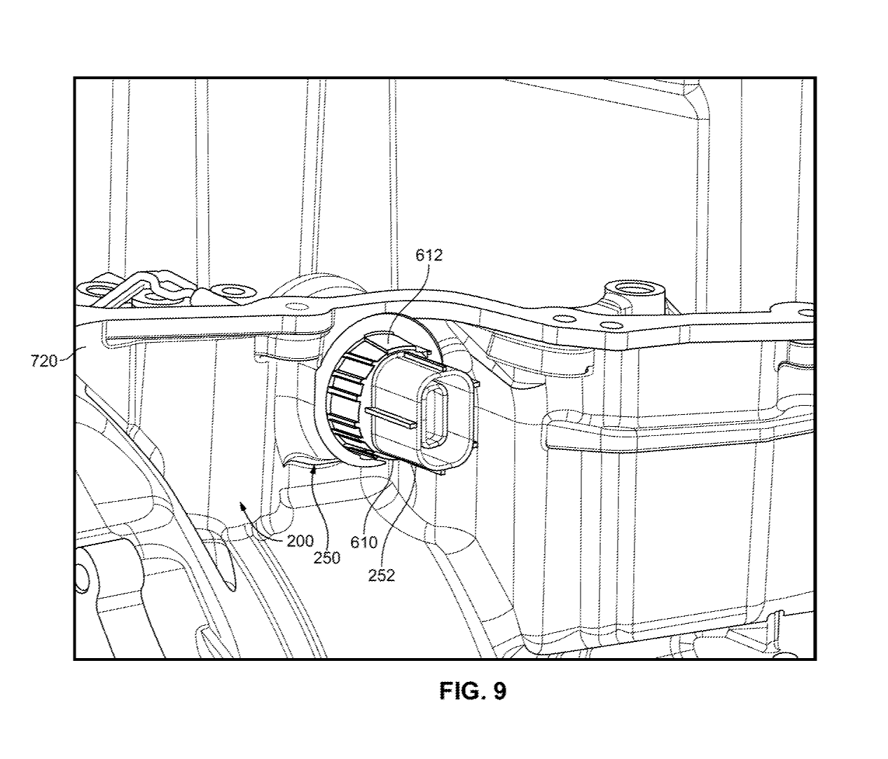

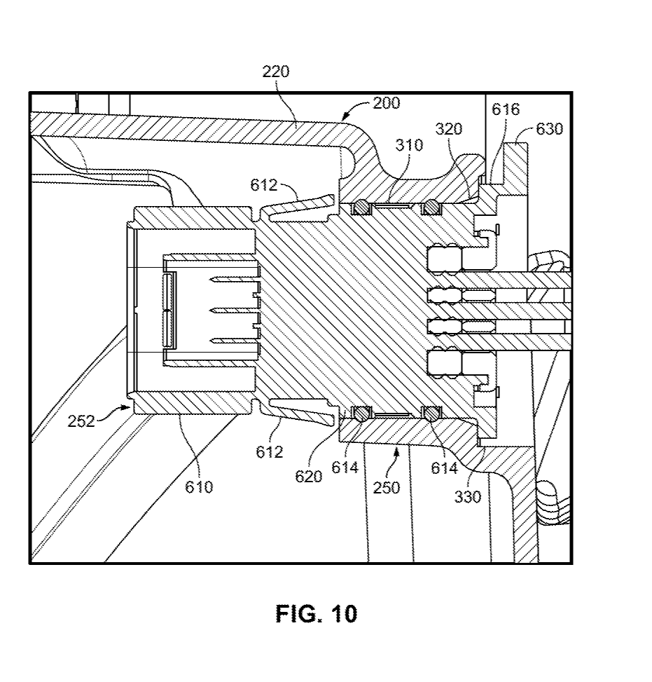

FIGS. 6-10 are views of the connector 252 engaging with the interface 250 and will be collectively discussed. In particular, FIG. 6 is a first isometric interior view of the interface 250 partially engaged with the connector 252 in a first position, and FIG. 7 is a second isometric interior view of the interface 250 partially engaged with the connector 252 in a second position, e.g., subsequent to the first position during assembly of the transmission. FIG. 8 is an isometric interior view of the interface 250 fully engaged with the connector 252, and FIG. 9 is an isometric exterior view of the interface 250 engaged with the connector 252. FIG. 10 is a cross-sectional view of the interface 250 engaged with the connector 252.

In general, the connector 252 has features that enable a secure engagement with the interface 250. Collectively, the interface 250 and connector 252 may be considered a “connection assembly.” As shown in FIGS. 6 and 7, the connector 252 is initially inserted into the interface 250 from the interior side. In one exemplary embodiment, the connector 252 includes an end portion 610, a sealing portion 620, and a rotation lock 630.

Typically, the end portion 610 is inserted into the interface 250 from the interior side. As discussed above, the end portion 610 is configured to mate with the exterior component or system that is to be electrically coupled to the component inside the transmission case 200. The end portion 610 has a smaller diameter than the interface 200, particularly smaller than the main cylinder 310, such that the end portion 610 passes axially through the interface 250 without obstruction. If the end portion 610 is radially misaligned with the main cylinder 310, the angled walls of the chamfer 320 guide the end portion 610 into the proper radial position, centered within the main cylinder 310.

As the end portion 610 passes through the interface 250, the sealing portion 620 of the connector 252 engages with the interface 250. Particularly, the sealing portion 620 includes at least one resilient tab 612 on the outer circumferential surface of the sealing portion 620. In the depicted embodiment, two tabs 612 are provided. As the sealing portion 620 passes through the interface 250, the tabs 612 are oriented to be depressed by the walls of the main cylinder 310. In a depressed position, the tabs 612 slide through the main cylinder 310. Upon clearing the main cylinder 310 in an axial direction, the tabs 612 are resiliently biased outward to a position outside of the diameter of the main cylinder 310. This position is best shown in FIGS. 9 and 10. In the extended position, the tabs 612 may engage the vertical face 360 on the exterior side of the side wall 220. This “snap-in” arrangement functions to prevent the connector 252 from being removed from the interface 250 in an opposite direction, e.g., prevents movement in an axial direction towards the interior side of the interface 250. If the connector 252 is to be removed from the interior side, tabs 612 may be manually depressed to enable axial movement back through the main cylinder 310.

The sealing portion 620 additionally includes at least one o-ring 614 that engages the interior wall of the main cylinder 310, as is best shown in FIG. 10. The o-rings 614 are resilient such that the o-rings 614 slide in an axial direction along the main cylinder 310 but provide a radial seal between the interface 250 and the connector 252. In the depicted embodiment, two o-rings 614 are provided, although other arrangements of o-rings and/or other radial seals are possible.

The sealing portion 620 additionally includes a flange 616. The flange 616 has a greater diameter than the main cylinder 310 and the chamfer 320. As best shown in FIG. 10, as the connector 252 is inserted into position within the interface 250, the flange 616 engages the interface 250 at the counterbore 330. This engagement functions to prevent additional axial movement of the connector 252 into the interface 250. As a result, the connector 252 is secured in both axial directions, e.g., the tabs 612 function to restrict axial movement in an interior axial direction and the flange 616 functions to restrict axial movement in an exterior axial direction.

As noted above, the connector 252 additionally includes a rotation lock 630. The rotation lock 630 is generally a semi-circular flange that extends about the top half of the connector 252 on the interior side. As is best shown in FIG. 8, the rotation lock 630 has ends 632 on either side of the semi-circular flange that are arranged to engage the ribs 350 when positioned within the interface 250. In one exemplary embodiment, the ends 632 are positioned within the same horizontal plane to match the horizontal plane of the ribs 350, although other configurations that enable the ends 632 to mate with the ribs 350 may be provided. As a result of the engagement of the ends 632 and ribs 350 on opposing sides of the interface 250, the connector 252 is prevented from rotating within the interface 250. Additionally, the two ribs 350 and semi-circular rotation lock 630 also function to radially align the connector 252 during assembly.

Accordingly, the interface 250 enables a secured engagement with the connector 252 to guide the connector 252 into proper position during assembly and to prevent movement after assembly. Particularly, the tabs 612 and flange 616 ensure proper axial positioning within the interface 250. The rotation lock 630 ensures proper circumferential positioning within the interface 250, and the chamfer 320 ensures proper radial positioning within the interface 250. As such, the connector 252 is secured in a known position to enable safer and more secure assembly within the automobile, for example, assembly by automated machinery. The engagement between interface 250 and the connector 252 enables secure positioning and coupling while being sealed off from the general environment.

As noted above, the interface 250 may be molded or cast with the case 200 and machined as necessary or desired. In one exemplary embodiment, the interface 250 may require only three axis of machining to save time and money during manufacture, e.g., as opposed to four or five axis machining. Typically, the interface 250 does not require a unique setup for machining nor tighter tolerances than other machined details on the transmission case. Moreover, the corresponding connectors 252 do not require tight tolerances that may be more expensive to produce. As such, the exemplary embodiments disclosed herein may save time on the assembly line, and may significantly reduce stops of the line to address installed component misalignment with automated machinery.

Although the interface 250 is discussed above with reference to a transmission case, the interface 250 may be provided in other types of cases or bodies. For example, exemplary embodiments may be utilized, for example, when an automated apparatus is required to mate to an auxiliary component installed as a pass through connection to any type of apparatus enclosed in a main body. Automated processes have low tolerances for positioning. In order for an automated device to properly mate to an ancillary component on a main body, it is often desirable to have a low tolerance of position both axially and radially. In particular, the interface 250 provides a simple and secure “snap-in” connection with the pass through connector 252. Additionally, the connector 252 discussed above is described as an electrical connection for providing power or control signals. However, in other embodiments, the connector 252 may guide air or other types of fluids through the case 200.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A transmission assembly, comprising:
a transmission case with at least one wall having an interior side and an exterior side;
a transmission component arranged within the transmission case;
an interface formed in the wall of the transmission case; and
a connector secured to the wall at the interface with a snap-in connection that substantially prevents axial, radial, and rotational movement between the connector and interface.

2. The transmission assembly of claim 1, wherein the interface includes a main cylinder extending through the wall of the transmission case.

3. The transmission assembly of claim 2, wherein the connector includes an end portion, a sealing portion, and a rotation lock, the end portion having a diameter configured to pass through the main cylinder to the exterior side of the wall.

4. The transmission assembly of claim 3, wherein the sealing portion includes an o-ring that forms a radial seal with the main cylinder.

5. The transmission assembly of claim 4, wherein the sealing portion further includes resilient tabs configured to be biased from a depressed position to an extended position such that the resilient tabs are depressed when passing through the main cylinder and snap into the extended position on the exterior side of the transmission case, and wherein the interface includes a vertical face on the exterior side of the wall that engages the resilient tabs to prevent movement in an axial direction from the exterior side to the interior side.

6. The transmission assembly of claim 5, wherein the interface further includes a chamfer axially adjacent to the main cylinder to guide the end portion and sealing portion into the main cylinder.

7. The transmission assembly of claim 6, wherein the interface further includes a counterbore axially adjacent to the chamfer and the connector further includes a flange to engage the counterbore to prevent movement in the axial direction from the interior side to the exterior side.

8. The transmission assembly of claim 7, wherein the interface further includes ribs for restricting the rotational movement between the connector and the interface.

9. The transmission assembly of claim 8, wherein the ribs include a first rib and a second rib, the first rib and the second rib being coplanar.

10. The transmission assembly of claim 9, wherein the first rib and the second rib are oriented horizontally.

11. The transmission assembly of claim 8, wherein the connector includes a flange with ends that mate with the ribs.

12. The transmission assembly of claim 1, wherein the connector is configured to electrically couple the transmission component to another component external to the transmission case.

13. The transmission assembly of claim 1, wherein the transmission component is a pump.

14. A connection assembly, comprising:
an interface formed in a wall of a case, the interface including a main cylinder extending through the wall, a chamfer on a first side of the main cylinder, a counterbore on the first side of the main cylinder, ribs on the first side of the main cylinder, and a vertical face on a second side of the main cylinder; and
a connector secured to the wall at the interface with a snap-in connection that substantially prevents axial, radial, and rotational movement between the connector and interface by engaging the main cylinder, the chamfer, the counterbore, the ribs, and the vertical face of the interface.

15. The connection assembly of claim 14, wherein the connector includes an o-ring that forms a radial seal with the main cylinder, resilient tabs configured to snap into an extended position and engage the vertical face, and a flange with ends that mate with the ribs.

16. A vehicle case, comprising:
a body;
walls coupled to the body to form an enclosure, the walls including a first wall with an interior side and an exterior side; and
an interface formed within the first wall to receive a pass through connector between a first component within the enclosure and a second component outside of the enclosure, the interface preventing axial, radial, and rotational movement between the connector and the interface.

17. The vehicle case of claim 16, wherein the interface includes a main cylinder extending through the first wall.

18. The vehicle case of claim 17, wherein the interface further includes a chamfer axially adjacent to the main cylinder, the chamfer configured to guide the connector into the main cylinder.

19. The vehicle case of claim 18, wherein the interface further includes a counterbore axially adjacent to the main cylinder.

20. The vehicle case of claim 19, wherein the interface further includes at least one rib for engaging a corresponding portion of the connector to prevent relative rotation.
